(19) United States
(12) Patent Application Publication
(10) Pub. No.: US 2015/0235282 A1
(43) Pub. Date: Aug. 20, 2015

(54) Method and system to share, interconnect and execute components and compute rewards to contributors for the collaborative solution of computational problems.

(71) Applicant: Purushotham Kamath, San Jose, CA (US)

(72) Inventor: Purushotham Kamath, San Jose, CA (US)

(21) Appl. No.: 14/182,298

(22) Filed: Feb. 18, 2014

(51) Int. Cl. G06Q 30/02; G06F 9/44; G06Q 10/10

(52) U.S. Cl. CPC G06Q 30/0283; G06Q 10/101; G06F 8/20

(57) ABSTRACT

A method and system that allows multiple developers to collaborate together by developing, modifying and sharing code components and data which are integrated to provide a solution to a computational problem. The system enforces a sharing mechanism for the components (code and data) and an interface between components. The system allows developers to execute the components either locally or remotely. The system determines a consumption metric based on the resource consumption of each component (compute/storage/bandwidth). The system determine a contribution metric for each developer's components to the overall solution. The system uses the contribution metric and the consumption metric and computes a reward for each developer proportional to his contribution

### RELATED US APPLICATION DATA

This application claims (under 37 CFR 1.78) the benefit of U.S. Provisional Application [61/766,838], filed on Feb. 20, 2013. (“Method to share, interconnect and execute components and reward contributors for the collaborative solution of computational problems”).

### FIELD OF INVENTION

The disclosed embodiments relate generally to distributed systems and methods for computation, and in particular to a system that allows the collaborative solution of computational problems by a community of developers, that computes developer's contributions, that computes resource consumption and that computes rewards to developers for contribution.

### BACKGROUND OF INVENTION

Distributed systems for computational problem involve solving a computational problem using a system of servers. Prior systems, algorithms and languages provide various means to solve problems in a distributed manner and to construct a distributed system from components.

The system described in this application provides a means to share code components among developers while enforcing component interfaces for the purpose of data exchange. In doing so, it provides a means to compute developer's contributions to a component, execute the components, compute resource consumption of the components and compute rewards to the components' developers. This is a novel method to reward developers who collaborate on a solution to a computational problem. This is also a novel method to charge the consumer utilizing the above components, and to publish, or to advertise the availability such components to the potential consumers.

### SUMMARY OF INVENTION

### Technical Problem

The problem is to provide a method and system that allows multiple developers to build a system that solves a computational problem and to compute rewards to developers for their contribution to the solution of the computational problem, to generate billing models for the consumers of such components, and to publish or to advertise the availability of such components to potential customers.

### Solution to Problem

The solution is
A system that allows multiple developers to collaborate together by developing, modifying and sharing code components and data which are integrated to provide a solution to a computational problem. The system enforces a sharing mechanism for the components (code and data) and an interface between components that allows components to be linked to form an application that is used to solve a computational problem. The system publishes components and their interfaces to allow developers to use them to build applications and for components to discover other components/interfaces.
The system determines a consumption metric based on the resource consumption of each component (compute/storage/bandwidth).
The system determines a contribution metric for each developer's components to the overall solution.
The system uses the contribution metric and the consumption metric and computes a reward for each developer proportional to his contribution.
The system uses the consumption metric and a value metric and computes a cost for each component and application

### Advantageous Effects of Invention

The system allows a developer community to solve computational problems in a distributed development model and be rewarded for their contribution. The system also publishes available services as well as billing models to potential customers and also targets potential customers.

### BRIEF DESCRIPTION OF DRAWINGS

FIG. 1 is a block diagram of the model used to allow collaboration, rewarding, publishing and billing.

FIG. 2 is a block diagram of an exemplary distributed system on which the embodiment is implemented. It shows execution processors, data stores and a communication network that connects them.

FIG. 3 is a block diagram of code components and data linked together through interfaces

FIG. 4 is a block diagram of one possible (but not the only) interconnection structure of components. It shows 5 code components and their input and output data.

FIG. 5 is a block diagram of an exemplary system used for predictive analysis. It shows components used for data acquisition, data cleaning, prediction, comparison and visualization of results.

FIG. 6 is a block diagram of an exemplary system used for feature recognition in images. It shows components used for data preparation, data cleaning, data format conversion, feature recognition of different features, comparison of results and a visualization of results.

FIG. 7 is a block diagram of the embodiment of the system that indicates how components (code/data) are added, modified, shared and how components are executed to achieve a solution to a computational problem.

### DESCRIPTION OF EMBODIMENTS

Component Based Contribution/Consumption/Reward/Publish/Charge Model

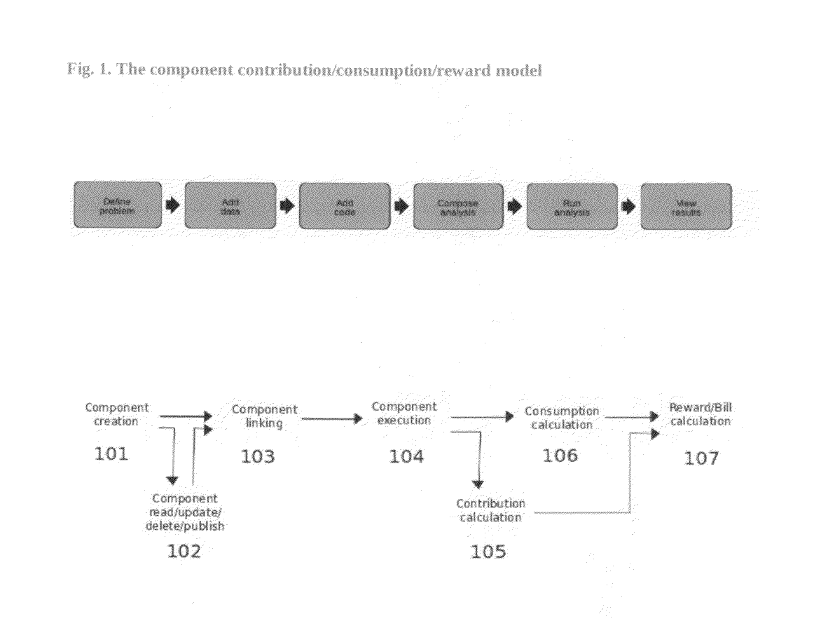

FIG. 1 is a block diagram of the component based contribution/consumption/reward model 100. This model is implemented on a system which consists of multiple processors and multiple data stores connected by multiple communication networks. The system is described in the next section.
The first operation of the model is code component and data creation 101 in which a code component or data is created on the system. A code component is a set of instructions written in a programming language (high level or machine), intended for execution (or translation to a form for execution) on a hardware processor (including but not limited to a CPU). The code component takes some input data, performs computation on the data and produces some output data. Data is a sequence of bits stored in any format. This first operation of the model consists of multiple sub-steps including but not limited to authoring the component in a programming language, authoring data in any format, naming the component or data, and transferring the component or data on to the system.
Subsequent to operation 101, further operations are applied to the code components/data. These operations include but are not limited to read, modification, deletion and renaming 102.
Subsequent to the execution of one or more iterations of operation 101, a link operation 103 is performed on a group of components and data. A link operation creates relationships between one or more code components and and one or more instances of data. A group of such linked components and data is called an Application. One example of a relationship is to map the input and output of a code component to specific instances data. Another example of a relationship is to map code and data to the vertices and edges of a directed graph. The link relationship information is stored on the system in a store, including but not limited to a database table or file.
Subsequent to operation 101, the components and interfaces are published through a service mechanism that allows other developers or components to discover them and their capabilities
Subsequent to operation 103, an execution operation 104 is performed on the application. The execution operation causes the linked components to be executed on the system. The code component reads data and writes data. The execution happens on any available processor, and is not limited to the processor where the components were created/stored or where the linkage was created/stored. The processor where execution occurs transfers the components, data and linkage information to itself, if needed and executes the components, reading the input and writing the output. It transfers the output data back to its original storage location. The execution and linkage is enabled by the interfaces between the components and data which is static (defined during component creation) or dynamic (changes during execution time).
Subsequent to operation 104, further operations are applied to the code components/data. These operations include but are not limited to transfer of the code or data to another data store.
Subsequent to operation 103, or 104, the system calculates a consumption metric 106 based on resource consumption during execution of the application or estimated resource consumption of the application. Resources that are consumed include but are not limited to computation time, storage, network bandwidth. Resource consumption is computed using an algorithm that combines these factors. Consumption of resources is calculated on a per component basis or on a per application basis.
Subsequent to operation 103, the system calculates a contribution metric 105 based on the contribution of each developer to the code components/data. The contribution is calculated using factors included but not limited to lines of code/data, complexity of algorithm and developer consensus. Contribution of a user is calculated on a per component basis or on a per application basis.
Subsequent to operation 103 or 104, the system calculates a value metric for an application or component. Factors that are used to compute the value include, but are not limited to the amount that a customer is willing to pay for an application/component or its output data. A customer is any entity who pays for a component, data or application or an interface to the data
Subsequent to operation 103 or 104, the system calculates a reward (positive) or a cost (negative reward) 107 for each developer based on the contribution metric 105 and the consumption metric 106 and the value metric. The system also calculates a billing for a customer based on the contribution metric 105 and the consumption metric 106 and the value metric. Reward/Billing for a user is calculated on a per component basis or on a per application basis or per resource consumed or per contribution made. The metrics 105, 106, 107 are used to calculate rewards/costs for both developers and customers.
The operations of (CONTRIBUTION/CONSUMPTION/REWARD/PUBLISH/BILLING) 107 are optional. Optional operations are operations that may be omitted without impacting operation of the system.

Distributed System for Computation

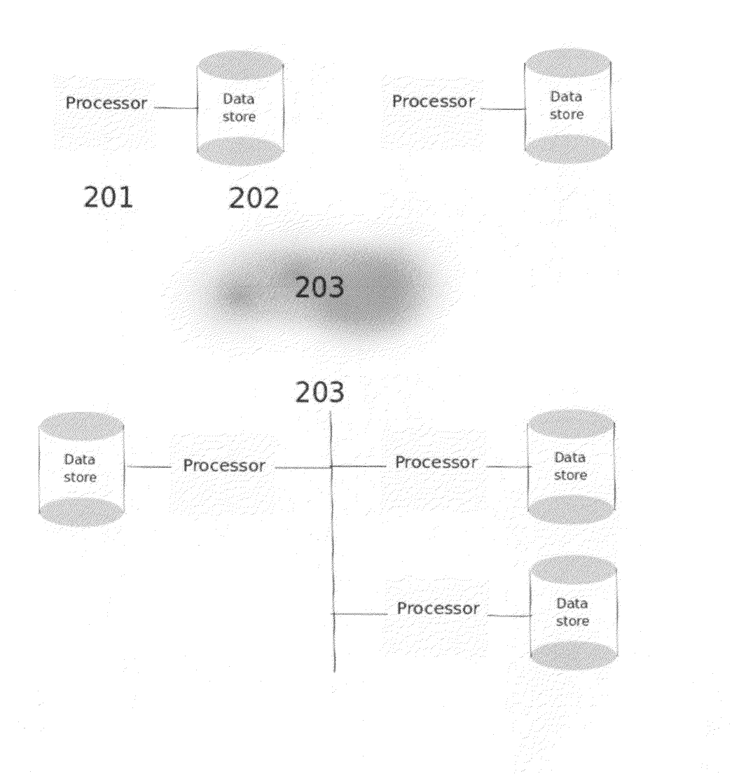

The Component Based Contribution/Publish/Consumption/Reward/Bill model is executed by software running on a distributed hardware system consisting of processors, data stores and networks. FIG. 2 is a block diagram of an exemplary distributed system 200 on which the model is implemented. The layout of the system in the figure is exemplary and the system runs on any layout suitable for the application.

The system consists of processors 201. Processors are responsible for
Hosting the software that presents the user interface to a developer
Hosting the software that provides the mechanism by which a developer writes/reads code/data to/from the system
Transferring data to/from data store from/to execution processor
Executing code components

The processors allow developers to author (operation 101), create (101), link (103), read, share, (103), read, share, publish (102), and execute (103) code components.

The system also has data stores 202 where the data/code components are stored. The data stores are built from dedicated data storage units or execution processors with attached data storage. The data stores host software including but not limited to databases, source code control systems, network files systems.

Components/data are transferred between the processors and data stores through a communication network 203. The communication network is a Local Area Network or a Wide Area Network or a combination of the two, the Internet, or an overlay on top of the Internet.

The layout shown in the diagram is an exemplary system. Processors are not limited in location and are local or remote to a developer, are static or mobile, are standalone or part of a cluster.

### Embodiment of Distributed System for Computation with the Component Based Collaboration/reward Model

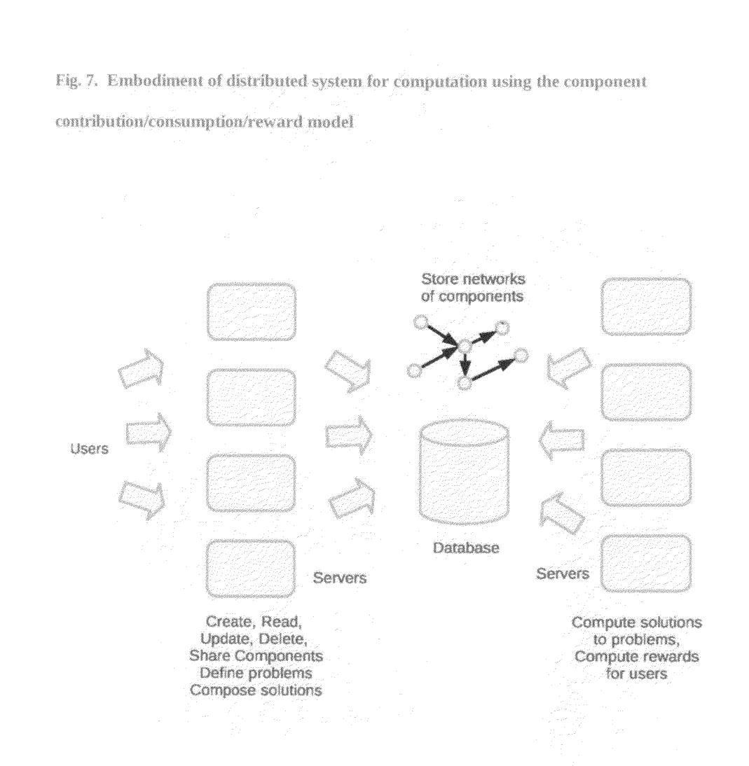

FIG. 7 is an embodiment of the distributed system for computation with the component based collaboration/reward/publish/bill model. The system enables computational components written by developers to be interconnected by other developers together in a structure that produces a solution to a computational problem.

Component/Data Creation/Read/Updation/Deletion

A code component is a computer program (written in high level or low level programming languages as known in the industry) with a well defined input and output data. It is a program that communicates with other components/external systems to get/put data, accepts input data, processes input data, computes solutions to a problem and generates output data, Data is any information stored in a sequence of bits that is used as input to a component or that is generated as the output of a component.

The system provides a means for developers to create and store code components/data on the system: The creation of a component consists of the following operations:
Naming the component
Authoring the component
Transferring the component
Sharing the component

All operations are provided through a User Interface which could be implemented through any means, including but not limited to a Graphical User Interface, a Command Line Interface or an Application Programming Interface.

Naming the Component:

Naming of the code components/data is done through the system's user interface which allows developers to provide a name for a component. The system generates a system wide unique name for the component.

During the component naming of the component, the following information (all or a subset) is provided by the developer:
For code, user access permissions (read, write/update, delete, execute), interface parameters (input and output data) and also to provide documentation for the component. The system allows code to be shared among users according to the user access permissions specified when the component was created. User access permissions are managed by the system using a mechanism built over other access permission mechanisms such as operating system file access permissions, database access permissions, or platform access permissions.
For data, the developer has the option to choose the type of data store or specify the data format and allow the system to choose the type of data store. The data store on the system are files on a file system, a bot stream, rows in a database table or files on a distributed network file system.

When a component is created the developer chooses the location and/or storage method for the code/data. The developer also chooses to allow the system to make the decision on the location or storage method.
Location specifies where the code/data is stored: The code/data is stored on a processor/storage node on the system, or remotely on the developer's processors/storage node, or on a third party processor/storage node
Storage method specifies how the code/data is stored: The code/data is stored as files on a file system, in a database (relational or non relational), on a source code control system or other storage mechanism.

The system makes this decision using an algorithm based on several factors, including but not limited to:
Data access requirements (including but not limited to structure/unstructured, ACID/BASE properties)
Data storage, bandwidth and computation costs
Data access interface (programming language used to write the component)
To optimize execution (based on criteria described in the execution processor selection algorithm).

After the decisions on Location/Storage are made, the system generates internal data structures to manage the Location/Storage of the code data. It creates a structure (such as a database table) which maps between components/data and their data store location and storage method.

This data structure, called the Location/Storage Map (LSM)

Location/Storage Map:

| | | |
|---|---|---|
| Component Name | Storage method | Location |

The Location/Storage map associates a name to a network location. This is used to create a published directory service which is accessible to users so that a named component is reachable over a network. The directory services are central or peer-to-peer. When central, a known central repository is queried to find out where all a named component is available. In a peer-to-peer model, the known deployments of the invention are queried to find out the availability. It is a persistent storage mechanism such as a relational database.

Authoring the Component:

The developer authors the component in a programming language and provides all files necessary to execute the component. In case of data, the developer authors or generates the data file using any means including but not limited to text editors, binary editors, sensors or data collectors. When authoring the code component, the author uses a system specified interface through a library to access input and output data.

Transferring the Component:

Once the code component has been created, the code is placed on the system through a suitable data transfer mechanism such as a file transfer protocol or a source code management system or other to transfer code/data from the developer's processor to the system's data store. Instead of uploading the component the developer optionally informs the system of the location of the component (a network address), and the system transfers the component when it needs it.

The data transfer mechanism used depends on the location chosen for the component and the data store type. The system knows the location/data store to be used for the component from its Location/Storage Map and will inform the developer of the appropriate data transfer method to use.

Sharing/Publishing the Component

The code components/data are shared among developers working on other processors. through a suitable sharing method (including but not limited to a file transfer protocol, source code management system, network file system).

Component Linking

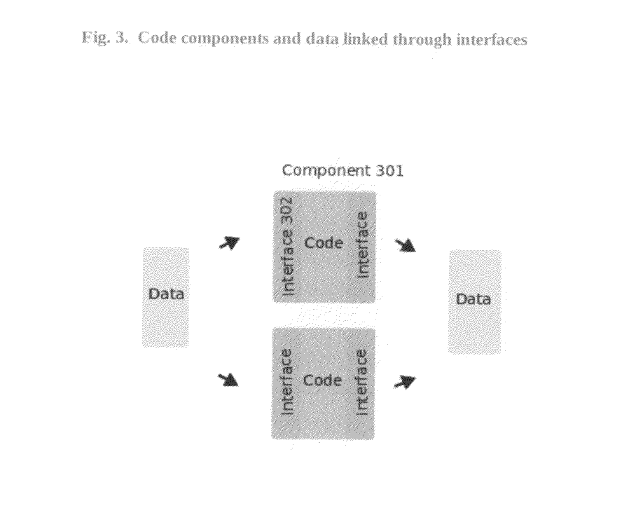

The system allow users to link multiple components using one of multiple interconnection methods. FIG. 3 shows code components and data linked together to create an application. A group of such linked components/data is called an Application. Code components communicate with each other through interfaces 302 through which they exchange data.

When a developer creates an application, the developer names the application. The system generates a system wide unique name for the application. The developer links components through a user interface. The user interface allows the developer to do the following two steps:
Select (one or more) code components. For each code component chosen, the developer chooses (one or more) input and output data. The code components and data are chosen from a list of components available on the system subject to the permissions on the components granted by the author.
Order the components in an sequence in which the components must be executed.

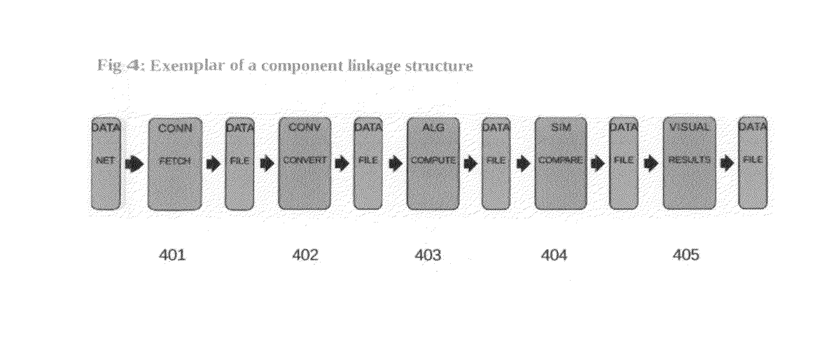

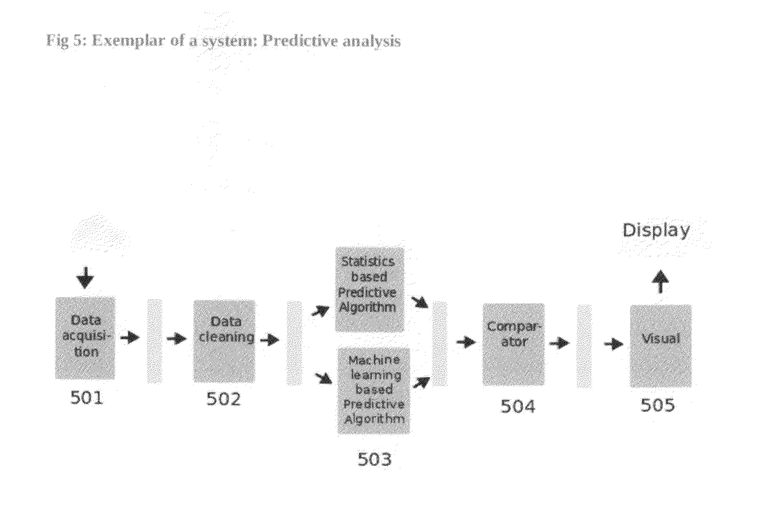

The user interface allows developers to choose multiple components and data for the application. This allow applications to be built in complex structures of components, data and links, including but not limited to directed/undirected graphs such as pipelines or trees. For example, FIG. 4 shows components connected in a pipeline (a single line with one path from start to finish), while FIG. 5 shows components connected in a graph with 2 possible paths from start to finish.

The system creates an internal data structure called the Link Map to store the links that make up the application. The Link map is a table which store the names of the code components along with the names of their input and output data. The Link Map is stored persistently on a storage mechanism such as a relational database. The Link Map is used to generate graphical representation of the structure. Link Maps from multiple systems are combined and published as a central directory service so that users can discover compute components. Link Maps track past users and post them updates and pricing promotions. Link Maps also integrate and maintain the charging information. Link Maps and directory services are maintained locally, or in a distributed manner. An application user profile consists of the set of components used by a user and associated link maps and so on. Application user profiles together with central or distributed repositories of Link Maps dynamically connect users with available applications and components. Application user profiles facilitate in building new Link Maps from the available components and submit the new Link Maps for approval and integration into the user application profiles. Further component pricing updates and new and alternative choices for components that are part of Link Map used in a user profile are pushed to the users so that the users are enabled to reconfigure their Link Maps.

Link Map for Application:

| | | | |
|---|---|---|---|
| Code Component | Input Data | Output Data | Order |
| name | component name(s) | component name(s) | |

When the component is authored as described in the section on Component Creation, it is written using a system specified interface to access the input and output data. The interface between components are chosen to meet any of the following:
components/data from one developer are interconnectable with components/data from other developers to form arbitrary structures.
components/data from one developer are replaceable with components/data from another developer
components/data are capable of being interconnected using private interfaces

The interfaces between components is public or private, and handles the following two functions internally:
Location determination
   The data store location is determined using the using the Location/Storage Map (created when the data was created on the system). A component reads the Location/Store map and looks up the location using the name of the data store.
Storage method determination
   The library provides access to all forms of data store, including native files, databases or distributed file systems. The library consists of an application programming interface which is similar to an operating system file system interface or a relational database query language interface or a distributed file system interface.

An example of an interface is a library with an API with the following functions:
open( ): Open a data store, by specifying the unique name for the data component
read( ): Read data from the data store
write( ): Write data to the data store
get( ): Get a specific piece of data based on some conditions
put( ): Put a specific piece of data based on some conditions
query( ): Query the data store
close( ): Close the data store

The functions use specify the data in the following possible ways:
Directly using unique name for the data chosen when the data is created on the system, described in the previous section
Indirectly using a handle to refer to the unique name for the data. The handle points to any data on the system

Because the code component must use the library's read/write interface, the system ensures that a component will be able to run with different input/output data, and that the same input/output data is used on a different component. The component takes care of reading the input data in the correct format and writing the output data in the correct format.

The underlying data store interface is chosen dynamically using the Location/Storage Map that links the name of the component to the type of data store (created when the data was created on the system).

FIG. 4 shows five components integrated in a linear structure. In this case, there are five code components CONN 401, which fetches data, CONV 402, which converts data from one format to another, ALG 403 which performs a computation, SIM 404 which performs another computation and VISUAL 405 which transforms the output into a format for visual display. There are five data components, which are stored in files. The code and data components are connected together in a pipeline. Note that this structure is an exemplar—the system is not limited to the structure shown i.e, the structure is an arbitrary network. An unlimited number of components are connectable together by any developer in arbitrary structures.

Components define and publish the interfaces that they use so that other components interface with them through data. The interfaces are made available to other components though means that include, but not limited to:
A repository of interface descriptions
An interface discovery protocol supporting push/pull notifications

Components linked to each other query each other for interfaces to use. Queries include but are not limited to querying to
Minimize Cost (dynamic cost computed based on instantaneous measurements or static performance based on estimation)
Maximize Performance (dynamic performance computed based on instantaneous measurements or static performance based on estimation)

The interface used depends on factors including but not limited to
The component implementation
Cost (billing based on the resource (computation/storage/bandwidth) consumption)
Performance

Component Execution

The system executes applications. An application is group of component and data linked together in any arbitrary structure. To execute an application, the system must do the following
Parse the Link Map, identify the code components/data components needed, and select the execution processor to execute the code. The execution processor is chosen using an algorithm described below. The location is the location where the code is stored, where the data is stored or a third location.
Transfer the components in an order specified in the Link Map, and transfer the code to the execution processor if needed. The transfer methods include file transfer protocols, source code control methods, network file systems or any other peer to peer or client/server transfer methods.
Transfer the input data in an order specified in the Link Map, and transfer the data to the execution processor if needed.
Execute the code component and transfer the output data to the appropriate storage location as specified in the Link Map, if needed.

There are two primary methods of execution:
Local execution by developers/users: The linked components are executed locally by users/developers. The components are executed on any computation processor (remote computation cluster, local processor, mobile processor). The procedure is initiated by the developer/user system which transfers code components/data to their local systems where execution occurs.
System Execution by system: The linked components are executed on the system. The system refers to its internal database and discovers the location of a code component and its input and output data and uses the execution processor selection algorithm to select the appropriate execution processor (s).

The system facilitates scheduled, conditional execution of applications by and for users. The outputs of certain monitoring applications, deployed by users or system management, are optionally directed to further trigger the execution of other applications when the outputs meet certain predefined application thresholds. A condition such as when the component price reaches certain threshold, trigger execution of an identified application.

Execution Processor(s) Selection Algorithm:

The system selects the execution processor(s) among a network of processors. It calculates several parameters over all possible execution processors, including but not limited to,
Input data transfer time: Time required to transfer the input data from its data store to the execution processor
Computation time: Time required for computation by the component on the execution process
Output data transfer time: Time required to transfer the output data from the execution processor to its data store.
Data transfer cost is dependent on a multivariable equation, an example cost model is Data transfer cost=Data transferred×Cost of data transfer
Computational cost is dependent on a multivariable equation, an example cost model is Computation cost=Computation time×Cost of computation time

It uses several criteria to select the execution processor, including but not limited to:
Minimize execution delay: All possible execution locations are considered and the a processor is chosen to minimize execution delay, where

Execution delay=input data transfer time+execution time+output data transfer time
Minimize cost All possible execution locations are considered and a processor is chosen to minimize execution cost. where

Execution cost=data transfer cost+execution cost+output data transfer cost
Hybrid algorithms which to choose a compromise between cost and delay or other criteria.

The execution processor transfers the code and data from their location to the execution processor, (if needed) and then starts the execution.

The results of the execution (computation) is output data (which could be input to other code components). This data is made available to one or more users for further processing/distribution subject to the user permission assigned when the data was created on the system.

Contribution Metrics

The system computes a metric that is directly related to the contribution of each component and its contributor(s) to the solution of the computational problem.

The contribution to a component is calculated by combining a number of criteria, including but not limited to
Lines of code added/contributed to the component
Complexity of the code added/contributed to the component
Compliance with is use of certain APIs

The method to calculate the contribution is implemented through a combination of source control and other software code tools. The tools calculate contribution based on various factors including but not limited to:
the number of lines contributed or based
the complexity weight of the problem solved by the developer, e.g. improvements in computational complexity, or based on on state machine complexity,
a user review which allows contributions to be changed based on consensus among developers. Users rate each contribution on a scale and each contribution is weighted based on the rates.

When a code/data component is created and added to the system by a developer, the developer's contribution is 100%. As other developers contribute to the component, they receive some credit for contribution.

One possible implementation:

Contribution of developer to component=Lines of code written by developer/Total lines of code)*Complexity weight

Normalized contribution=Contribution Of developer/Sum of all contributions Complexity weight=a number between 0 and 1 which measure the complexity of the contribution

When code/data components are linked together to form an application, each component contributes to the application. The contribution fraction for each component to the application is calculated based on a number of factors, including but not limited to:
the component type
a system defined mapping
complexity weight of the component, based on its function or complexity
by consensus among developers.

One possible implementation:

Contribution of component to application=Component factor/Number of components in application

Normalized contribution=Contribution of component/Sum of all contributions

where component factor is a fraction that depends on the type of components.

When two components perform comparable functions within an application such as different algorithms for the same problem, the output data of components is compared. A comparison mechanism could be another component called a “comparator” which uses the output data of the components and compares them to each other (or to base results) and determines which component is the “better” algorithm using a comparison algorithm (using an objective function). This allows the components to be ranked based on quality of results and computation, communication or storage efficiency.

First the contribution of the component to the application is calculated assuming there are no other comparable components. The the contribution metrics of each comparable component to the application is calculated from the ranking, and the component contribution:

Contribution of a comparable component=(Weight based on rank/Number of comparable components)×Contribution of component

Normalized contribution=Contribution of component/Sum of all contributions

An option to assign negative credits to a component contribution, based on unfavorable application adoption experience is available. A negative credit is assigned by subject matter experts after quantified either a review feedback, or application execution experience, or other feedback mechanisms. Components are dynamically decommissioned when negative credits reach certain thresholds, however, system management can override this action. When components are decommissioned link maps are reoptimized and user profiles are updated.

When components are decommissioned certain applications will become unavailable. Exception triggers are provided to accommodate decommissioned components and continued support of applications and related link maps.

Value Metric

Based on the potential value of a component/data or an application, a value metric is calculated for the component or the application. The value is assigned by a developer, by the system or by a customer who wishes to buy or access the component/data. The value metric is calculated using various metrics including but not limited to
Complexity of the component, data
Market value of the data or computation of the data

The value metric of a system is used to compute a billing for a customer and the reward for the developer and the system. Billing is be done separately for component/applications based on their value or on their resource consumption.

Consumption Metrics

Components consume various resources during execution. They include, but are not limited to:
Bandwidth (BW): Bandwidth of the network is consumed during data transfer. Bandwidth is used to measure the network capacity. It is measured in units of Gb transferred in and out of a processor/storage. Cost is measured in Dollars/Gb/s. Dollars here refers to any form of payment including various currencies or tokens or forms of credit.
Storage: Data storage costs include permanent storage of the code/data as well as transient storage. It is measured in GB. Cost is measured in Dollars/GB
Compute: Compute costs are the cost of processors. It is measured in hours of compute time. Cost is measured in Dollars/computation time period.

The system computes a metric that is directly related to the resources (computation, communication and storage) consumed in the solution of the problem.

Determination of consumption is dependent on multiple variables. For example, measurement of consumption of a component=Sum (BW cost*Data transferred+Storage cost*Data stored+Computation cost*Computation hours) for a component

For example, measurement of consumption of an application=Sum (BW cost*Data transferred+Storage cost*Data stored+Computation cost*Computation) for all components of an application

Many other resources are used during the execution. These include but are not limited to:
Application Programming Interfaces (APIs) from the system or third party
Services from the system or third party

In each case, the component will use some resource which has an associated cost. These costs are optionally added to the cost of execution of the component.

So, total consumption=System resource (compute/storage/bandwidth) consumption+Other consumption (system/third party API or service)

Reward Metrics

The system computes a reward (based on the contribution and consumption metrics) to each developer for his contribution to the solution of the problem.

The system estimates the reward to a developer from three parameters:
Value for an application=From the revenue (or potential revenue) of the application, Value of application=Revenue (or potential revenue) from application
Consumption cost of app=function (Consumption fraction of component, Consumption of app).
Contribution share if developer=function (Contribution of developer to component, Contribution of a component to app)

Reward calculation is dependent on multiple variables. An e.g. calculation model of reward to developer=function (Developer contribution to component, Component contribution to app, Consumption fraction of component, Consumption of app, Value of component, Value of app)

E.g., one possible reward function is

Developer Reward=(Developer contribution to component*(Value of component−Consumption of component)) for all components in an app.

or Developer reward=Developer contribution to app*(Value of app−Consumption of app)

Based on this calculation each developer who contributes to the application is rewarded for his contribution. Based on the calculation a decision to either reward or not reward a developer or to reward a negative credit is made.

Not all metric calculation operations (Contribution, Consumption, Value) are necessary, and when designated so, a selected set of metric calculation operations could be omitted without impacting operation of the system. E.g. the contribution and value metric calculations are optional, and if needed, the system will omit them, in which case the reward is negative i.e. a cost to the developer.

The contribution is computed before the before the execution of an application. The resources consumed are computed during the execution and the reward is computed after execution. However all parameters are computed at any time. If any parameter is computed before being available, it is an estimation rather than a measured value.

Exemplary Systems

System 1

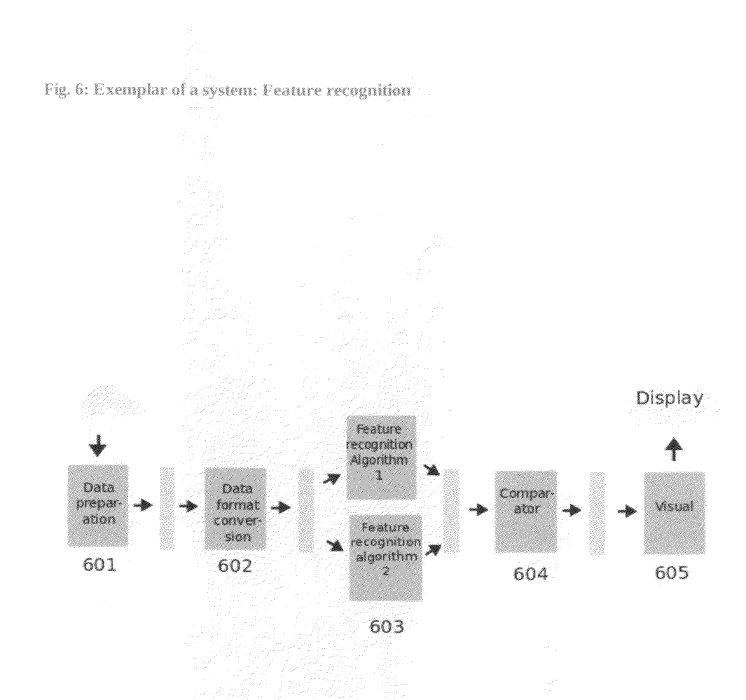

FIG. 6 shows an exemplary system used for predictive analysis. A computational problem such as predictive analysis is solvable by a number of different algorithms. The domain for which predictive analysis is required could be very diverse, including but not limited to domains such as stock market trends, sports games prediction, weather prediction. The algorithms which could be applied to these domain could be very diverse, including but not limited to statistical analysis, machine learning. The feature set (the set of inputs to the algorithms) to be used for prediction could also be very diverse. Communities of developers have different expertise in different domains and algorithms. To allow different communities to work on the same data and reuse each other's processed data, it would be necessary to have a system with a common framework for data exchange and connecting the components together. The system provides this framework.

Code components/data/applications are created/read/updated/linked/published/shared as described in the embodiment section.

An application is designed to use different algorithms to make the same domain prediction. The input to the algorithms and the outputs of the algorithms would be common. The system allows different developers to add their own algorithms to solve the problem. More developers add suitable visualizations for the results.

Such a system would also have a method to compare the different algorithms to an “optimal” or “perfect” prediction. The system provides an answer to the question of which algorithm is performs better based on some metric to measure prediction. An example of a metric to measure performance might be to use a common training set to training the algorithms and a common test set to test the algorithms.

The system applies all the algorithms to predictions for new data with the results ranked based on the performance of the algorithms on the test set of data.

Each developer is rewarded in a manner proportional to the effort involved in developing their component and in the resources their components consume and the performance of their algorithms

FIG. 5 shows the components in the system for data acquisition 501, data cleaning 502, predictive analysis using different algorithms (statistical/machine learning), 503 and comparators 504 to compare accuracy of the predictors and visualizations 505 to present the results.

System 2

FIG. 6 shows an exemplary system used for feature recognition in images. The problem is broken into several components pipelined together. Each component has different depending on the domain of the data. Communities of developers have different expertise in different areas. To allows different communities to work on the same data and reuse each other's processed data, it would be necessary to have a system with a common framework for data exchange and connecting the components together. The system provides this framework.

The system is used for image processing by defining components to do data preparation 601, format conversion 602, algorithms for feature recognition 603, and comparators 604 to compare accuracy of the image recognition.

Code components/data/applications are created/read/updated/linked/published/shared as described in the embodiment section.

When the final system is used for detection, each developer is rewarded in a manner proportional to the effort involved in developing their component and in the resources their components consume.

This exemplar is extended to systems for searching, processing, analyzing and visualizing a large data store. The data store varies from web documents, to images to sound files. The processing required varies from natural language processing to image processing. Analysis could vary from similarity detection to clustering to classification.

### CITATION LIST

### Patent Literature

“US Patent Application 20050204334/A1” (Parthasarathy, Sundararajan and others) discloses a method to independently test and develop components by capturing specifications in a model.
U.S. Pat. No. 8,095,911 (B. Ronen and N. Rostoker) discloses a method to utilize or reuse development components by presenting an interface to a remote user displaying information about the components.
U.S. Pat. No. 7,406,687 (L. Daynes and G. Czajkowski) discloses a method to share byte-code of a component using a first class and second class loader which translates a class file at run time.
U.S. Pat. No. 8,132,149 (M. Shenfield and R. B. Goring and D. Mateescu) discloses a method to coordinate development of application components (data, message and screen).
U.S. Pat. No. 7,802,230 (V. L. Mendicino and D. V. Wodtke) discloses a method to improve integration of software components by receiving metadata that defines the interface.
U.S. Pat. No. 7,499,899 (N. Siegel and M. Penedo) discloses a method to dynamically integrate components into new systems through connectors.
“EP0937285 B1” (I. Miloushev and P. Nickolov) discloses a method construct software components and systems as assemblies of independent software parts

### Non Patent Literature

“Connecting software components with declarative glue” (B. Beach) discloses a method to connect components using a declarative method.
“Archjava: Connecting software architecture to implementation” (J. Aldrich and C. Chambers and D. Notkin) discloses a method to enforce architecture constraints in the implementation of software components.
“Architecture-level support for software component deployment in resource constrained environments” (M. Mikic-Rakic and N. Medvidovic) discloses methods for software component deployment using architecture support.
“Common Object Resource Broker Architecture” http://www.omg.org/spec/CORBA/3.3/, Object Management Group is a method for interconnecting components.
“Java virtual Machine specification”: Tim Lindholm, Frank Yellin, Gilad Bracha, Alex Buckley, Tim Lindholm, http://docs.oracle.com/javase/specs/jvms/se7/html is a specification of a means of execution of code within a virtual machine.
Universal Plug and Play specification http://upnp.org/sdcps-and-certification/standards/UPnP Forum is a method to discover and communicate between services
Fielding, Roy T.; Taylor, Richard N. (May 2002), “Principled Design of the Modern Web Architecture” (PDF), ACM Transactions on Internet Technology (TOIT) (New York: Association for Computing Machinery) 2 (2): 115-150 is a method to interface between services

What is claimed is:

1. The present invention relates to a system that enables code components written by several contributors and data to be interconnected by other users together in a structure that produces a solution to a computational problem. The system comprises:
code components and data, where code components are software programs that produces output data by computation on some input data, where input data is the output data of another code component or data from some other external or internal source; and
a means by which two or more of the code components and data are interconnected by means of an interface for data exchange between the components; and
a means by which code components and data are created, stored remote or local to the system, located, published, shared among multiple users; and
a means by which user contribution to code components/data is computed; and
a means by which code components are executed and resource consumption is computed; and
a means by which rewards to users/authors for contribution are computed

2. The system of claim 1 wherein the computational problem is a batch processing problem, an interactive data analysis problem or a streaming data problem or another computational problem on data.

3. The system of claim 1 wherein two or more components are integrated using an interface chosen dynamically from a set of interfaces that specify the multiple input and output data to be exchanged between the components.

4. The system of claim 1 wherein an unlimited number of components are connected together by any user in arbitrary structures for the purpose of solving a large computation problem.

5. The system of claim 1 wherein multiple such structures of interconnected components are executed simultaneously using a scheduling mechanism optimized for resource consumption (computation, communication, storage, and others) based on the component interconnection structure.

6. The system of claim 1 wherein the output data of components is compared by other components for the purpose of ranking the components based on quality of solution and resource (computation, communication or storage) consumption.

7. The system of claim 1 wherein the computation results are made available to multiple users for further processing/distribution.

8. The system of claim 1 wherein it computes metrics for each user and component that relate the contribution of each user to each component and to the solution of the computational problem

9. The system of claim 1 wherein it computes metrics that relate to the consumption of resources (computation, communication, storage) by each component

10. The system of claim 1 wherein it computes a reward to the user for their contribution to the solution of the problem

11. The system of claim 1 wherein the components are executed on any processor, remote, local or mobile.

12. The system of claim 1 where resource consumption measurement/estimation is done on any system, local or remote.

13. The system of claim 1 where contribution measurement/estimation is done on any system local or remote.

14. The system of claim 1 where reward computation is done on any system local or remote.

15. The system of claim 1 where a multitude of methods are used for computation (including but not limited to local, remote or mobile).

16. The system of claim 1 where a multitude of methods are used for storage (including but not limited to files, databases, key value stores, document stores).

17. The system of claim 1 where a multitude of methods are used for communication i.e. transferring code and data (including but not limited to file transfer protocol, source code control).

18. The system of claim 1 where the computation, storage and communication and other resource consumption are used to select the processor and storage for the execution and storage of the components and data
